(19) United States
(12) Patent Application Publication
(10) Pub. No.: US 2009/0033592 A1
(43) Pub. Date: Feb. 5, 2009

(54) PLASMA DISPLAY DEVICE AND DRIVING METHOD THEREOF

(76) Inventors: Seung-Pil Mun, Suwon-si (KR); Eiji Ito, Suwon-si (KR); Luck-Hyun Kim, Suwon-si (KR); Dae-Young Kim, Suwon-si (KR)

Correspondence Address: CHRISTIE, PARKER & HALE, LLP, PO BOX 7068, PASADENA, CA, 91109-7068, US

(21) Appl. No.: 12/036,150

(22) Filed: Feb. 22, 2008

(30) Foreign Application Priority Data
Aug. 2, 2007 (KR) 10-2007-0077725

(51) Int. Cl. G09G 3/28

(52) U.S. Cl. 345/60

(57) ABSTRACT

A plasma display device including a scan circuit, a plasma display panel, and a plurality of power sources for driving the plasma display panel. The scan circuit is configured to apply scan voltages to scan electrodes of the plasma display panel in order to select light-emitting cells and non-light-emitting cells during an address period. The scan circuit includes a capacitor configured to remove the need to provide a current cut-off switch to prevent undesirable current flowing between the power supplies during the operation of the plasma display.

### CROSS-REFERENCE TO RELATED APPLICATION

This application claims priority to and the benefit of Korean Patent Application No. 10-2007-0077725 filed in the Korean Intellectual Property Office on Aug. 02, 2007, the entire content of which is incorporated herein by reference.

### BACKGROUND OF THE INVENTION

1. Field of the Invention

The present invention relates to a plasma display device and its driving method.

2. Description of the Related Art

The plasma display device is a display device using a plasma display panel (PDP) that displays characters or images by using plasma generated by a gas discharge. The PDP includes a plurality of scan electrodes and a plurality of sustain electrodes extending in pairs in a row direction on a first substrate, and a plurality of address electrodes extending in a column direction on a second substrate facing the first substrate. In general, the plasma display device is driven (operated) by dividing a single frame into multiple sub-fields having respective luminance weight values. During a reset period of each subfield, cells at crossings of the electrodes are initialized through reset discharges. During an address period, scan pulses are selectively applied to the plurality of scan electrodes by using an integration circuit (IC). During a sustain period, in order to display an actual image, sustain pulses each alternately having a high level voltage and a low level voltage are applied to the scan electrodes that perform sustain discharges.

Generally, a reference voltage (e.g., 0V) is used as the low level voltage of the sustain pulses, and a negative voltage is used as a voltage of the scan pulses. Thus, a driving circuit that drives the scan electrodes includes a transistor for applying the low level voltage to the scan electrodes and a transistor for applying the negative voltage to the scan electrodes. When the negative voltage is applied to the scan electrodes, a current path is formed between a transistor for applying the low level voltage to the scan electrodes and a transistor for applying the negative voltage to the scan electrodes. Thus, a switch element (e.g., a transistor) for cutting off the current path is provided by using two transistors in a driving circuit that drives the scan electrodes. In this manner, extra transistors are used in the driving circuit, and the unit cost is undesirably increased.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

The present invention has been made in an effort to provide a plasma display device and its driving method having advantages of reducing a cost of the driving circuit.

An exemplary embodiment of the present invention provides a plasma display device including a plasma display panel having a plurality of scan electrodes, a plurality of sustain electrodes, and a plurality of address electrodes. The plasma display panel is configured to be driven in a reset period, an address period, and a sustain period. A scan circuit is provided for driving the plurality of scan electrodes. The scan circuit includes a first input terminal, a second input terminal, and an output terminal. The output terminal is coupled to the scan electrodes and configured to provide a voltage of the first input terminal or a voltage of the second input terminal. A capacitor to be charged with a first voltage is provided and includes a first terminal coupled to the first input terminal of the scan circuit and a second terminal coupled to the second input terminal of the scan circuit. A first transistor is provided and coupled between the first terminal of the capacitor and a first power source for supplying a second voltage lower than the first voltage.

Another exemplary embodiment of the present invention provides a method for driving a plasma display device. The plasma display device includes a plasma display panel having a plurality of scan electrodes, a plurality of sustain electrodes, and a plurality of address electrodes. The plasma display also include a scan circuit for driving the plasma display panel in a reset period, an address period, and a sustain period. The scan circuit includes an output terminal coupled to the scan electrodes, a first input terminal, and a second input terminal. The output terminal of the scan circuit is configured to provide a voltage of the first input terminal or a voltage of the second input terminal. A capacitor is provided and have a first terminal coupled to the first input terminal and a second terminal coupled to the second input terminal. The method includes applying a reset voltage to the plurality of scan electrodes during the reset period; applying a scan voltage corresponding to a scan pulse to the plurality of scan electrodes through the second input terminal of the scan circuit during the address period; and applying a sustain voltage alternatively having a high level voltage and a low level voltage to the plurality of scan electrodes through the first input terminal of the scan circuit during the sustain period.

Yet another exemplary embodiment of the present invention provides a plasma display device including a plasma display panel having a plurality of scan electrodes, a plurality of sustain electrodes, and a plurality of address electrodes. The plasma display panel is configured to be driven in a reset period, an address period, and a sustain period. A first transistor is provided and has a first terminal coupled to the scan electrodes. A second transistor is provided and has a second terminal coupled to the scan electrodes. A capacitor is provided and configured to be charged with a capacitor voltage and have a third terminal coupled to a fourth terminal of the first transistor and a fifth terminal coupled to a sixth terminal of the second transistor. A sustain driver is provided and coupled to the fourth terminal of the first transistor and configured to supply sustain pulses each alternately having a high level voltage and a low level voltage to the scan electrodes.

### BRIEF DESCRIPTION OF THE DRAWINGS

FIG. 1 is a schematic drawing illustrating a plasma display device according to an exemplary embodiment of the present invention.

FIG. 2 is a drawing illustrating driving waveforms of the plasma display device according to the exemplary embodiment of the present invention.

FIG. 3 is a schematic drawing illustrating a scan electrode driving circuit according to the exemplary embodiment of the present invention.

FIGS. 4A to 4C are schematic drawings respectively illustrating current paths according to an operation of a scan electrode driving circuit.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. When it is described that an element is connected to another element, the element may be directly connected to the other element or connected to the other element through a third element.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. Because a threshold voltage of a semiconductor device (e.g., a transistor or a diode, etc.) is very low compared with a discharge voltage of a PDP, the threshold voltage can be considered as 0V and approximately processed. Thus, voltage applied to a node or an electrode, etc., by a power source includes voltage which has been changed due to the threshold voltage or a parasitic component, etc., from the voltage of the power source.

The plasma display device and its driving method according to the exemplary embodiment of the present invention will now be described in detail.

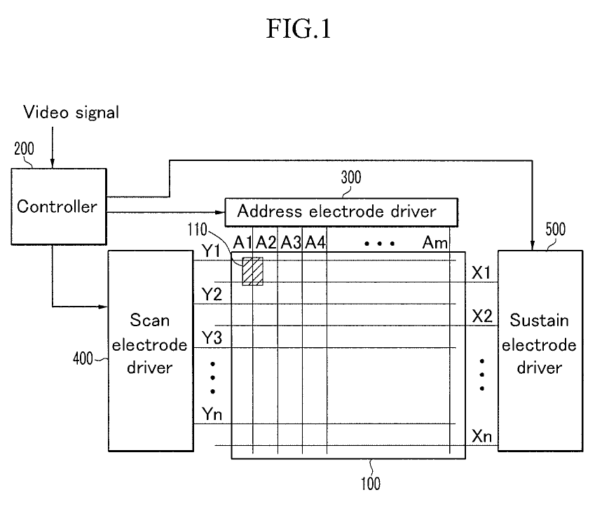

FIG. 1 is a schematic drawing illustrating a plasma display device according to an exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes (hereinafter referred to as ‘A electrodes’) A1˜Am extending in a column direction on a first substrate (not shown), and a plurality of sustain electrodes (hereinafter referred to as ‘X electrodes’) X1˜Xn and a plurality of scan electrodes (hereinafter referred to as ‘Y electrodes’) Y1˜Yn extending in a row direction as pairs on a second substrate (not shown). In general, the X electrodes X1˜Xn are formed to correspond to respective Y electrodes Y1˜Yn, and the X electrodes X1˜Xn and the Y electrodes Y1˜Yn perform a display operation to display an image during a sustain period. The Y electrodes Y1˜Yn and the X electrodes X1˜Xn are disposed to be perpendicular to the A electrodes A1˜Am. Discharge spaces at crossings of the A electrodes A1˜Am and the X and Y electrodes X1˜Xn and Y1˜Yn form discharge cells 110. Such a structure of the PDP 100 is an exemplary embodiment, and a panel with a different structure applied with driving waveforms to be described hereinbelow can be also applied for the present invention.

The controller 200 receives a video signal from an exterior source and outputs an A electrode driving control signal, an X electrode driving control signal, and a Y electrode driving control signal. The controller 200 divides a single frame into a plurality of subfields and the PDP 100 is driven in these subfields.

The address electrode driver 300 applies a driving voltage to the plurality of A electrodes A1˜Am according to the A electrode driving control signal from the controller 200.

The scan electrode driver 400 applies a driving voltage to the plurality of Y electrodes Y1˜Yn according to the Y electrode driving control signal from the controller 200.

The sustain electrode driver 500 applies a driving voltage to the plurality of X electrodes X1˜Xn according to the X electrode driving control signal from the controller 200.

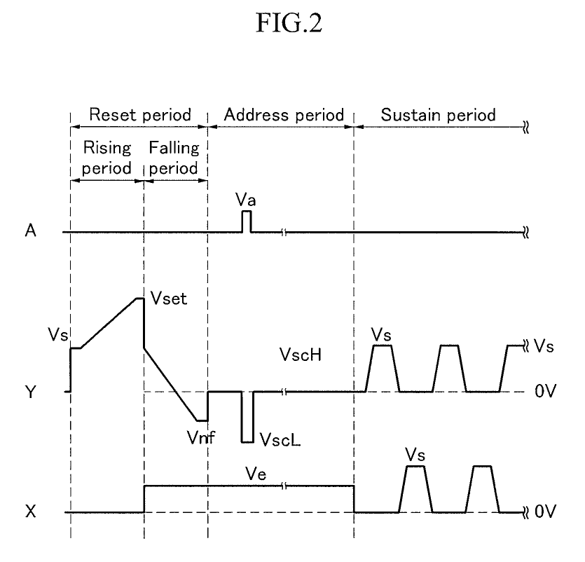

FIG. 2 is a drawing illustrating driving waveforms of the plasma display device according to the exemplary embodiment of the present invention. Specifically, FIG. 2 only shows driving waveforms of one of the plurality of subfields constituting the single frame and driving waveforms applied to the X electrode (X), the Y electrode (Y) and the A electrode (A) of a single discharge cell 110.

As shown in FIG. 2, during a rising period of a reset period, the address electrode driver 300 and the sustain electrode driver 500 bias, respectively, the A and X electrodes to a reference voltage (e.g., 0V in FIG. 2), and the scan electrode driver 400 gradually increases the voltage of the Y electrode from a voltage Vs to a voltage Vset. In FIG. 2, the voltage of the Y electrode is increased in a ramp pattern. Then, a weak discharge occurs between the Y and X electrodes and between the Y and A electrodes while the voltage of the Y electrode is being increased, forming negative (−) wall charges on the Y electrode and positive (+) wall charges in the X and A electrodes.

During a falling period of the reset period, the sustain electrode driver 500 biases the X electrode to a voltage Ve, and the scan electrode driver 400 gradually reduces the voltage of the Y electrode from the voltage Vs to a voltage Vnf. In FIG. 2, the voltage of the Y electrode is reduced in the ramp pattern. Then, a weak discharge occurs between the Y and X electrodes and between the Y and A electrodes while the voltage of the Y electrode is being reduced, erasing the negative (−) wall charges on the Y electrode and the positive (+) wall charges formed on the X and A electrodes. In general, the (Vnf−Ve) voltage is set to be close to a discharge firing voltage between the Y and X electrodes. Thus, a wall voltage between the Y and X electrodes is nearly 0V to thereby prevent a cell, in which an address discharge did not occur during an address period, from misfiring in the sustain period.

Subsequently, in order to select light emitting cells during the address period, the scan electrode driver 400 applies scan pulses of a voltage VscL to the Y electrodes (Y) while the sustain electrode driver 500 maintains the voltage of the X electrodes (X) at a voltage Ve. In this case, the address electrode driver 300 applies address pulses of a voltage Va to the A electrodes (A) of cells 110 selected to be light emitting among the plurality of cells 110 at crossings of the Y electrodes (Y) and the X electrodes (X) to which the voltage VscL has been applied, and applies voltage 0V lower than the voltage Va to the A electrodes (A) that pass through non-light emitting cells. Then, address discharges occur between the A electrodes (A) to which the voltage Va has been applied and the Y electrodes (Y) to which the voltage VscL has been applied and between the Y electrodes (Y) to which the voltage VscL voltage has been applied and the X electrodes (X) to which the voltage Ve has been applied, forming negative (−) wall charges on the X and A electrodes (X and A). The scan electrode driver 400 applies a voltage VscH, higher than the voltage VscL, to the Y electrodes (Y) to which the voltage VscL has not been applied.

In detail, during the address period, the scan electrode driver 400 and the address electrode driver 300 apply the scan pulses to the Y electrode (Y1 shown in FIG. 1) of the first row, and at the same time, apply the address pulses to the A electrodes corresponding to light emitting cells of the first row. Then, address discharges occur between the Y electrode of the first row and the A electrodes to which the address pulses have been applied, forming the positive (+) wall charges on the Y electrode and the negative (−) wall charges on the A and X electrodes. Subsequently, the scan electrode driver 400 and the address electrode driver 300 apply the address pulses to the A electrodes corresponding to the light emitting cells of the second row while applying scan pulses to the Y electrode (Y2 shown in FIG. 1) of the second row. Then, address discharges occur at the cells corresponding to the A electrodes to which the address pulses have been applied and the Y electrode of the second row, forming wall charges on the cells. Likewise, the scan electrode driver 400 and the address electrode driver 300 apply address pulses to the A electrodes corresponding to the light emitting cells while sequentially applying scan pulses to the Y electrodes of the remaining rows, forming wall charges.

Sequentially, during the sustain period, the scan electrode driver 400 applies the sustain pulses each alternately having a high level voltage (the voltage Vs shown in FIG. 2) and a low level voltage (0V shown in FIG. 2) to the Y electrodes by the number corresponding to the weight values of the corresponding subfields. Also, the sustain electrode driver 500 applies sustain pulses having the opposite phase to that applied to the Y electrodes to the X electrodes. Thus, a voltage difference between the Y electrodes and the corresponding X electrodes alternately has the voltage Vs and a voltage −Vs, and accordingly, the sustain discharges occur repeatedly by a certain number of times at the light emitting cells.

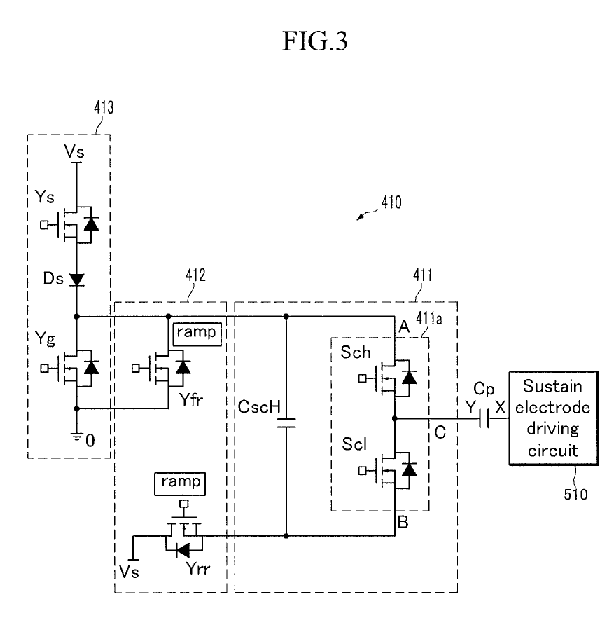

FIG. 3 is a schematic drawing illustrating a scan electrode driving circuit 410 according to an exemplary embodiment of the present invention. The scan electrode driving circuit 410 may be part of the scan electrode driver 400, and a sustain electrode driving circuit 510 connected with the X electrodes (X) may be part of the sustain electrode driver 500. For ease of explanation, only a single Y electrode (Y) is shown, and a capacitance component formed by the single Y electrode (Y) and a single X electrode (X) is shown as a panel capacitor Cp.

As shown in FIG. 3, the scan electrode driving circuit 410 includes a scan driver 411, a reset driver 412, and a sustain driver 413. The scan driver 411 includes a scan circuit 411a and a capacitor CscH, and the reset driver 412 includes transistors Yrr and Yfr. The sustain driver 413 includes transistors Ys, Yg, and a diode Ds. In FIG. 3, the transistors Ys, Yg, Yrr, Yfr, Sch, and Scl are shown as n-channel field effect transistors, namely, N-channel metal oxide semiconductor transistors (NMOS), in which a body diode may be formed in a direction from a source to a drain. In place of the NMOS transistors, different transistors having a similar function may be also used. When the transistors Ys, Yg, Yrr, Yfr, Sch, and Scl are insulated gate bi-polar transistors (IGBTs), diodes can be connected in parallel to the transistors Ys, Yg, Yrr, Yfr, Sch, and Scl.

First, the scan circuit 411a includes an upper input terminal (A) and a lower input terminal (B). An output terminal (C) is connected with the Y electrode (Y). In order to select light-emitting cells during the address period, voltage at the upper input terminal (A) and voltage at the lower input terminal (B) are selectively applied to the 25 corresponding Y electrode (Y). In FIG. 3, although it is shown that the single scan circuit 411a is connected with the Y electrode (Y), actually, the scan circuit 411a is connected with the plurality of Y electrodes (i.e., Y1˜Yn shown in FIG. 1). In addition, a certain number of scan circuits 411a can be formed as a single IC, and a plurality of output terminals of the IC may be connected with a certain number of Y electrodes (e.g., Y1˜Yk wherein ‘k’ is an integer smaller than ‘n’). The scan circuit 411a includes transistors Sch and Scl. A source of the transistor Sch and a drain of the transistor Scl are connected with the Y electrode (Y) of the panel capacitor Cp. A drain of the transistor Sch is connected with the upper input terminal (A), and a source of the transistor Scl is connected with the lower input terminal (B). A first terminal of the capacitor CscH is connected with the upper input terminal (A) of the scan circuit 411a, and a second terminal of the capacitor CscH is connected with the lower input terminal (B) of the scan circuit 411a. A voltage VscH is charged in the capacitor CscH. The capacitor CscH can be charged with the voltage VscH by connecting a charging switch (not shown) to the lower input terminal (B) of the scan circuit 411a, or may receive the voltage VscH from an output terminal of a switching mode power supply (not shown). In the latter case, the charging switch may not be used.

A drain of the transistor Yrr, whose source is connected with a the second terminal of the capacitor CscH, is connected with the power source Vs that supplies the high level voltage (e.g., the voltage Vs in FIG. 2) of the sustain pulse, and a source of the transistor Yfr, whose drain is connected with the first terminal of the capacitor CscH, is connected with a ground terminal that supplies the low level voltage (e.g., 0V in FIG. 2) of the sustain pulse. In this case, when the transistor Yrr is turned on, it is operated to allow a small current to flow from its drain to its source to cause the voltage of the Y electrode to be gradually increased in the ramp pattern to the voltage Vset, and when the transistor Yfr is turned on, it is operated such that a small current flows from its drain to its source to allow the voltage of the Y electrode to be gradually reduced to the voltage Vnf (refer to FIG. 2). In FIG. 2, it is shown that the voltage Vnf and the voltage VscL can be the same, and in this case, if the voltage Vnf is higher than the voltage VscL, a Zener diode may be connected between the drain of the transistor Yfr and the first terminal of the capacitor CscH. Then, the voltage Vnf, as a voltage higher by a breakdown voltage of the Zener diode than the voltage VscL, can be provided.

A source of the transistor Ys and a drain of the transistor Yg are coupled to the upper input terminal (A) of the scan circuit 411a. A drain of the transistor Ys is connected with the power source Vs and a source of the transistor Yg is connected with the ground terminal (e.g., 0V). In another embodiment, a diode Ds is connected between the upper input terminal (A) of the scan circuit 411a and the source of the transistor Ys. Namely, an anode of the diode Ds is connected with the source of the transistor Ys, and a cathode of the diode Ds is connected with the upper input terminal (A) of the scan circuit 411a. When the transistor Yrr is turned on, the diode Ds cuts off a current path formed to the power source Vs through the body diode of the transistor Ys. In another embodiment, the diode Ds may be connected between the power source Vs and the transistor Ys.

The sustain driver 413 may further include a power recovery circuit (not shown) that may be connected to a contact between the two transistors Ys and Yg and recover reactive power of the sustain pulses to re-use it. An exemplary power recovery circuit is disclosed in U.S. Pat. Nos. 4,866,349 and 5,081,400 by L. F. Weber.

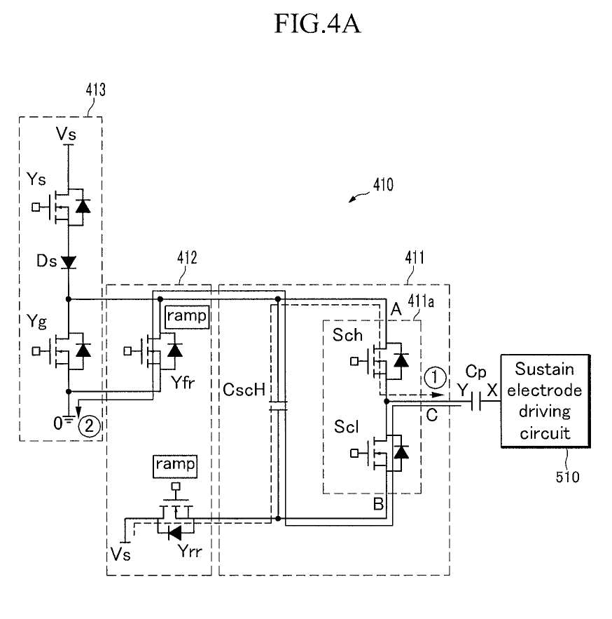

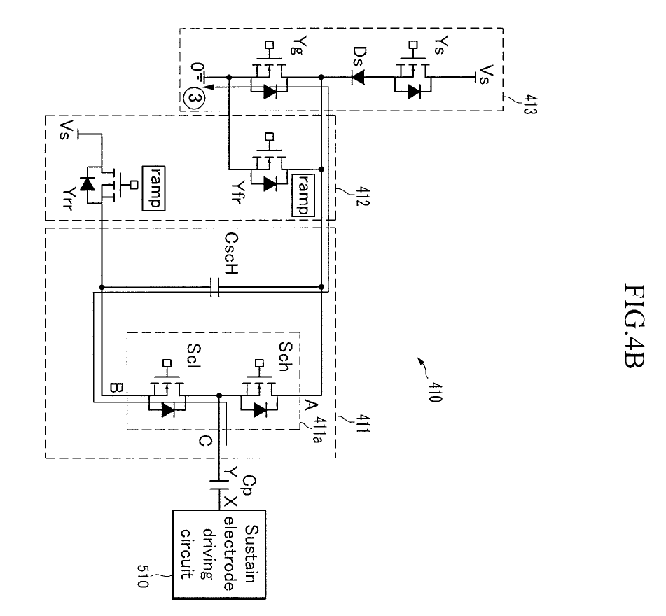

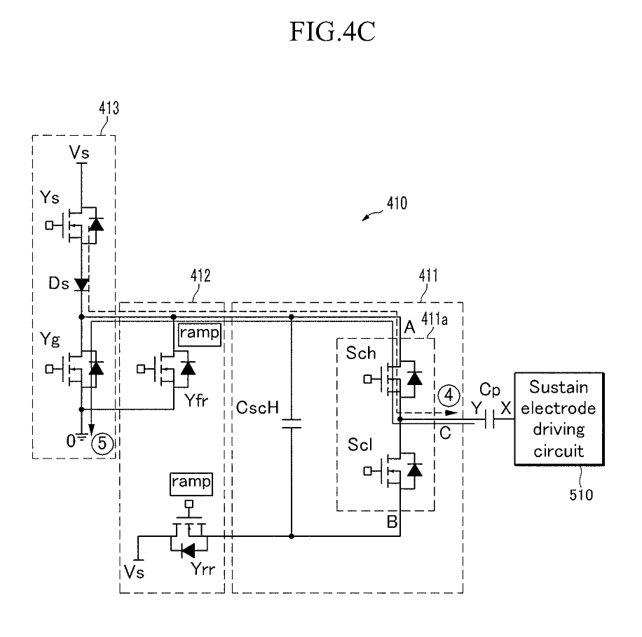

The operation of the scan electrode driving circuit 410 as shown in FIG. 3 will now be described in detail with reference to FIGS. 4A to 4C.

FIGS. 4A to 4C are schematic drawings respectively illustrating the operations of the scan electrode driving circuit 410 during the reset period, the address period, and the sustain period. First, it is assumed that before the rising period of the reset period, the transistors Ys and Sch are turned on to apply the voltage Vs to the Y electrode (Y).

During the rising period of the reset period, the transistor Yrr is turned on and the transistor Ys is turned off. Then, as shown in FIG. 4A, voltage of the Y electrode (Y) gradually increases from the voltage Vs to a voltage (Vs+VscH−VscL) through a path formed by the power source Vs, the transistor Yrr, the capacitor CscH, the transistor Sch, and the Y electrode (Y) (\textcircled{1}). In the exemplary embodiment of the present invention, it is assumed that the voltage (Vs+VscH−VscL) is the same as the voltage Vset (shown in FIG. 2, for example).

In the falling period of the reset period, the transistors Yfr and Scl are turned on, and the transistors Yrr and Sch are turned off. Then, as shown in FIG. 4A, the voltage of the Y electrode (Y) is gradually reduced to −(VscH−VscL) voltage through a path formed by the Y electrode (Y), the transistor Scl, the capacitor CscH, the transistor Yfr, and the ground terminal (\textcircled{2}). In the exemplary embodiment of the present invention, it is assumed that −(VscH−VscL) voltage is the same as the voltage Vnf (shown in FIG. 2, for example).

Referring to FIG. 4B, during the address period, in a state that the transistor Yg is turned on, the transistors Sch and Scl are selectively turned on. In this case, when the transistor Scl is turned on, as shown in FIG. 4B, the −(VscH−VscL) voltage is applied to the Y electrode (Y) through a path formed by the Y electrode, the transistor Scl, the capacitor CscH, the transistor Yg, and the ground terminal (\textcircled{3}). If the transistor Sch is turned on, 0V is applied to the Y electrode (Y). In the exemplary embodiment of the present invention, it is assumed that the voltage VscL is the same as Vnf, and the voltage VscH is the same as 0V. In this manner, because the light emitting cells and the non-light emitting cells are selected by using both voltages of the capacitor CscH, an extra power source for supplying the voltage VscL is not necessary and a transistor connected between the power source supplying the VscL and the Y electrode is not necessary. In addition, because the transistor connected between the power source supplying the voltage VscL and the Y electrode is not necessary, a transistor for cutting off a current path including the transistor, connected between the power source for supplying the voltage VscL and the Y electrode, and the transistor Yg is not necessary.

During the sustain period, the transistor Scl is turned off and the transistor Ys is turned on. Then, as shown in FIG. 4C, the voltage Vs is applied to the Y electrode (Y) through a path including the power source Vs, the transistor Ys, the diode Ds, the transistor Sch, and the Y electrode (Y) (\textcircled{4}).

Thereafter, during the sustain period, the transistor Ys is turned off, and the transistor Yg is turned on. Then, as shown in FIG. 4C, 0V is applied to the Y electrode (Y) through a path including the Y electrode (Y), the body diode of the transistor Sch, the transistor Yg, and the ground terminal (\textcircled{5}).

During the sustain period, the operation as shown in FIG. 4C can be repeatedly performed by the number of times corresponding to the weight value of the corresponding subfield to thus apply the sustain pulses each alternately having the voltages Vs and 0V to the Y electrode (Y).

While this invention has been described in connection with what is presently considered to be practical exemplary embodiments, it is to be understood that the invention is not limited to the disclosed embodiments, but is intended to cover various modifications and equivalent arrangements included within the spirit and scope of the appended claims.

As described above, the plasma display device and its driving method according to embodiments of the present invention, use reduced number of transistors for driving the scan electrodes. Accordingly, the cost of the driving circuit that drives the scan electrodes can be reduced.

What is claimed is:

1. A plasma display device comprising:
a plasma display panel having a plurality of scan electrodes, the plasma display panel configured to be driven in a reset period, an address period, and a sustain period;
a scan circuit for driving the plurality of scan electrodes, the scan circuit comprising a first input terminal, a second input terminal, and an output terminal, the output terminal being coupled to the scan electrodes and configured to provide a voltage of the first input terminal or a voltage of the second input terminal;
a capacitor to be charged with a first voltage and comprising a first terminal coupled to the first input terminal of the scan circuit and a second terminal coupled to the second input terminal of the scan circuit; and
a first transistor coupled between the first terminal of the capacitor and a first power source for supplying a second voltage that is lower than the first voltage.

2. The device of claim 1, wherein, during the address period, the first transistor is turned on, and the scan circuit is configured to provide the voltage of the first input terminal or the voltage of the second input terminal at the output terminal.

3. The device of claim 2, further comprising:
a second transistor coupled between the first terminal of the capacitor and a second power source for supplying a third voltage that is higher than the second voltage, wherein, during the sustain period, the first transistor and the second transistor are alternately turned on.

4. The device of claim 3, wherein, during the sustain period, the output terminal of the scan circuit is configured to couple to the first input terminal.

5. The device of claim 3, further comprising:
a third transistor coupled in parallel to the first transistor and configured to gradually reduce voltages of the plurality of scan electrodes.

6. The device of claim 3, further comprising:
a third transistor coupled between the second terminal of the capacitor and a third power source for supplying a fourth voltage that is higher than the second voltage, and configured to gradually increase voltages of the plurality of scan electrodes.

7. A method for driving a plasma display device comprising a plasma display panel having a plurality of scan electrodes; a scan circuit for driving the plasma display panel in a reset period, an address period, and a sustain period, the scan circuit having an output terminal coupled to the scan electrodes, a first input terminal and a second input terminal, the output terminal of the scan circuit configured to provide a voltage of the first input terminal or at voltage of the second input terminal; and a capacitor having a first terminal coupled to the first input terminal and a second terminal coupled to the second input terminal; the method comprising:
applying a reset voltage to the plurality of scan electrodes during the reset period;
applying a scan pulse to the plurality of scan electrodes through the second input terminal of the scan circuit during the address period; and
applying a sustain pulse alternately having a high level voltage and a low level voltage to the plurality of scan electrodes through the first input terminal of the scan circuit during the sustain period.

8. The method of claim 7, wherein the applying of the scan pulse comprises:
supplying a reference voltage to the first terminal of the capacitor; and
configuring the scan circuit to couple the output terminal to the second input terminal of the capacitor,
wherein the second terminal of the capacitor is charged with a voltage.

9. The method of claim 8, wherein a low voltage level of the scan pulse is lower than a low voltage level of the sustain voltage.

10. The method of claim 8, wherein the applying a reset voltage to the plurality of scan electrodes during the reset period comprises:
gradually increasing the voltages of the scan electrodes from a first voltage to a second voltage through the first input terminal of the scan circuit; and
gradually decreasing the voltages of the scan electrodes from a third voltage to a fourth voltage through the second input terminal of the scan circuit.

11. The method of claim 10,
wherein the gradually decreasing the voltages of the scan electrodes comprises turning on a first transistor coupled between a first power source for supplying the reference voltage and the first terminal of the capacitor, the first transistor being operated to gradually decrease the voltages of the scan electrodes; and
the gradually increasing the voltages of the scan electrodes comprises turning on a second transistor coupled between the second terminal of the capacitor and a second power source for supplying the voltage charged at the second terminal of the capacitor, the second transistor being operated to gradually increase the voltages of the scan electrodes.

12. A plasma display device comprising:
a plasma display panel having a plurality of scan electrodes, the plasma display panel configured to be driven in a reset period, an address period, and a sustain period;
a first transistor having a first terminal coupled to the scan electrodes;
a second transistor having a second terminal coupled to the scan electrodes;
a capacitor configured to be charged with a capacitor voltage and having a third terminal coupled to a fourth terminal of the first transistor and a fifth terminal coupled to a sixth terminal of the second transistor; and
a sustain driver coupled to the fourth terminal of the first transistor and configured to supply sustain pulses each alternately having a high level voltage and a low level voltage to the scan electrodes.

13. The device of claim 12, wherein the sustain driver comprises:
a third transistor coupled between the scan electrodes and a first power source for supplying a first voltage; and
a fourth transistor coupled between the scan electrodes and a second power source for supplying a second voltage, the second voltage being lower than the first voltage,
wherein the second transistor and the fourth transistor are turned on during an address period.

14. The device of claim 13, wherein the sustain driver further comprises:
a diode coupled between the first power source and the third transistor or between the third transistor and the scan electrodes.

15. The device of claim 12, further comprising:
a third transistor coupled between the third terminal of the capacitor and a first power source for supplying a first voltage, and configured to gradually decrease the voltages of the scan electrodes,
wherein the third transistor and the second transistor are turned on during a first period of a reset period.

16. The device of claim 15, further comprising:
a fourth transistor coupled between the fifth terminal of the capacitor and a second power source for supplying a second voltage higher than the first voltage, and configured to gradually increase the voltages of the scan electrodes,
wherein the fourth transistor and the first transistor are turned on during a second period, different from the first period, of the reset period.

17. The device of claim 16, wherein the first voltage is the same as the lower level voltage, and the second voltage is the same as the high level voltage.
